(19) United States
(12) Patent Application Publication
(10) Pub. No.: US 2019/0246574 A1
(43) Pub. Date: Aug. 15, 2019

(54) PLANTING DISH AND PLANTING METHOD

(71) Applicant: Tzu-Hsin SUN, Taichung City (TW)

(72) Inventor: Tzu-Hsin SUN, Taichung City (TW)

(21) Appl. No.: 15/895,457

(22) Filed: Feb. 13, 2018

(51) Int. Cl. A01G 13/02; A01G 27/00

(52) U.S. Cl. CPC A01G 13/0281; A01G 27/00

(57) ABSTRACT

A planting dish has a dish body with a central hole and two plate members. Each plate member includes inner and outer edges, first and second side portions, a top surface defined by the inner and outer edges and the first and second side portions, and first and second securing members on the respective first and second side portions. The top surfaces cooperatively form a conical top surface that slope downward from the outer edges to the inner edges. The first side portion of one of the plate members is removably juxtaposed with the second side portion of the other plate member, with first securing member on each of the plate members being releaseably engageable with the second securing member on the other plate member.

### FIELD

The disclosure relates to an agricultural peripheral, and more particularly to a planting dish and a planting method.

### BACKGROUND

Non-chemical weed control methods have been commonly sought after to ensure proper growth of crops in an open field, as weed competes with other plants for water, air and nutrient from soil. Since manually cultivating the field for weed removal is costly, one may choose to cover the soil of the field with a tarpaulin, which has been modified with punctured holes to allow crops to extend therethrough, while trapping the weed underneath from being exposed to air, water and sunlight. However, as the tarpaulin is waterproof, if an automated sprinkling system is utilized, the tarpaulin may not be able to guide sprinkled water toward the punctured holes to water roots of the crops.

### SUMMARY

Therefore, an object of the disclosure is to provide a planting dish that can alleviate at least one of the drawbacks of the prior art.

Another object of the disclosure is to provide a planting method utilizing the planting dish.

According to one aspect of the disclosure, a planting dish for growing a plant in a ground area has a dish body and a fastening unit. The dish body is made from a water-impervious material and is configured to surround the plant and to cover a region of the ground area immediately above a root of the plant. The dish body includes a central hole for the plant to pass therethrough, at least two plate members which are arranged in an annular array. Each of the plate members includes an inner edge that surrounds and adjoins the central hole, an outer edge that surrounds the inner edge, a first side portion that is connected between the inner edge and the outer edge, a second side portion that is connected between the inner edge and the outer edge and that is angularly spaced apart from the first side portion, a top surface defined by the inner and outer edges and the first and second side portions. The top surfaces of the plate members cooperatively form a conical top surface that slope downward from the outer edges to the inner edges of the plate members.

The first side portion of each of the plate members and the second side portion of the other one of the plate members are juxtaposed with each other and are movable away from each other to allow access of the plant to the central hole. The fastening unit includes a first securing member formed on the first side portion of each of the plate members, and a second securing member formed on the second side portion of each of the plate members.

According to another aspect of the disclosure, a planting method includes providing a planting dish, planting a plant into a ground, and placing the planting dish around the plant.

The planting dish is made from a water-impervious material and includes a dish body. The dish body has a central hole, an annular inner edge surrounding and adjoining the central hole, an annular outer edge surrounding the annular inner edge, a top conical surface that is defined between the annular inner and outer edges and that slopes downward from the annular outer edge to the annular inner edge, and at least one split that extends from the central hole to the annular outer edge to intersect the annular inner and outer edges and that is openable to allow access from the annular outer edge to the central hole.

The planting dish is placed around the plant in such a manner that the plant extends through the central hole and the dish body covers at least a region of the ground area immediately above the root of the plant. The plant is placed in the central hole when the at least one split is opened. After the plant is placed in the central hole, the at least one split is closed.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating a first embodiment of a planting dish according to the disclosure;

FIG. 2 is an assembled perspective view of the first embodiment;

FIG. 3 is a fragmentary sectional view taken along line III-III of FIG. 2;

FIG. 4 is a fragmentary sectional view taken along line IV-IV of FIG. 2;

FIG. 5 is sectional view of the first embodiment in use;

FIG. 6 is a perspective view of a plate member of a second embodiment of the planting dish; and

FIG. 7 is a sectional view of the second embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

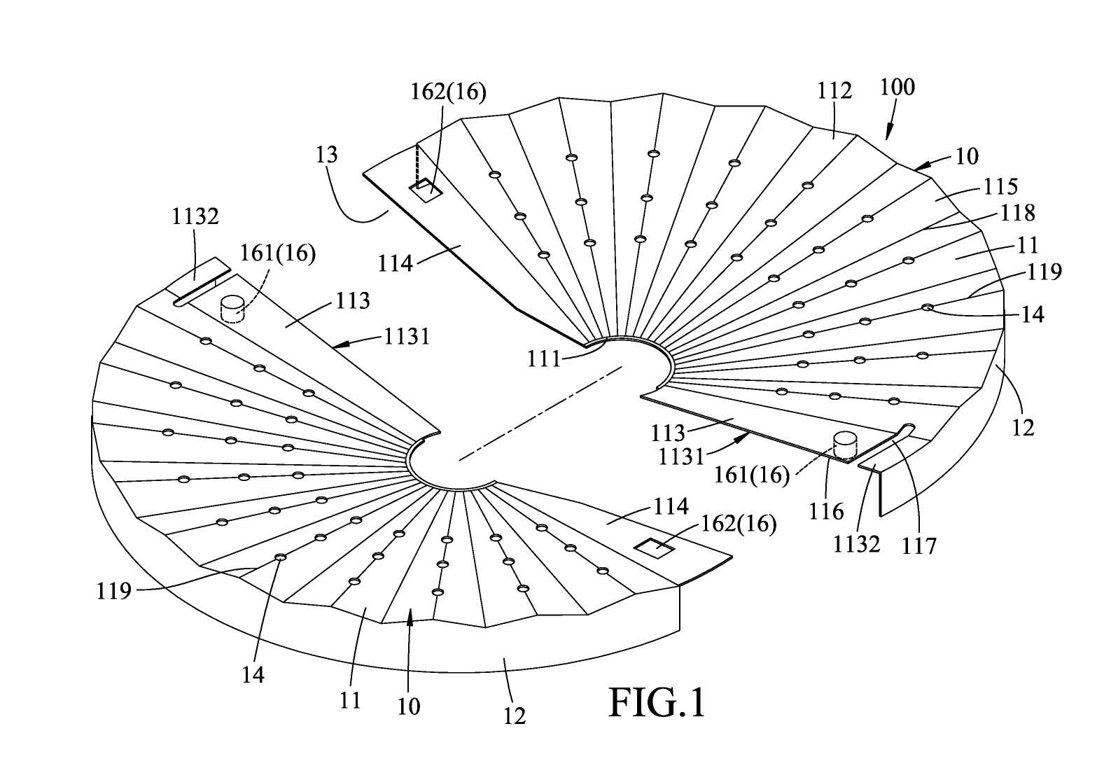

Referring to FIGS. 1 to 5, the first embodiment of the planting dish 100 according to the disclosure is used for growing a plant in a ground area, and has a dish body 10 that is made of an impervious material such as plastics. The dish body 10 is configured to surround the plant and to cover a region of the ground area immediately above a root of the plant. The dish body 10 includes a central hole 110 for the plant to pass therethrough and at least two plate members 11 which are arranged in an annular array around the central hole.

Each of the plate members 11 includes an inner edge 111 that surrounds and adjoins the central hole 110 an outer edge 112 that surrounds the inner edge 111, a first side portion 113 that is connected between the inner edge 111 and the outer edge 112, a second side portion 114 that is connected between the inner edge 111 and the outer edge 112 and that is angularly spaced apart from the first side portion, a fastening unit 16, a top surface 115 defined by the inner and outer edges 111, 112 and the first and second side portions 113, 114, a bottom surface 116 opposite to the top surface 115, and a slit 117 that is formed in the first side portion 113. In addition, each of the plate members 11 is formed with a plurality of guiding grooves 118 that are slopingly indented from the top surface 115 between the first and second side portions 113, 114 and that radially extend from the inner edge 111 to the outer edge 112, and a plurality of ridge portions 119 that protrude from the top surface 115 and that alternate with the guiding grooves 118.

The top surfaces 115 of the plate members 11 cooperatively form a conical top surface that slopes downward from the outer edges 112 to the inner edges 111 of the plate members. Each of the plate members 11 further includes a peripheral wall 12 that peripherally and downwardly projects from the outer edge 112. The peripheral walls 12 and the bottom surfaces 116 of the plate members 11 cooperatively define a space 13 that opens downward for placement of fertilizers. The first side portion 113 of each of the plate members 11 and the second side portion 114 of the other one of the plate members 11 are juxtaposed with each other and are movable away from each other to allow access of the plant to the central hole 110.

The fastening unit 16 of each of the plate members 11 includes a first securing member 161 formed on the first side portion 113 as a protrusion protruding downward from the bottom surface 116, and a second securing member 162 formed on the second side portion 114 as a through hole extending through the top surface 115 and the bottom surface 116 for engagement of the protrusion. To be more specific, the first securing member 161 on each of the plate members 11 is releaseably engagable with the second securing member 162 on the other one of the plate members 11.

The slit 117 of each of the plate members 11 extends through the top and bottom surfaces 115, 116 in the first side portion 113 and intersects a terminating edge 1131 of the first side portion 113 connected between the inner and outer edges 111,112. The slit 117 extends between the first securing member 161 and the outer edge 112 to form a flap section 1132 that is formed between the outer edge 112 and the slit 117 and that is separated from a remaining part of the first side portion 113.

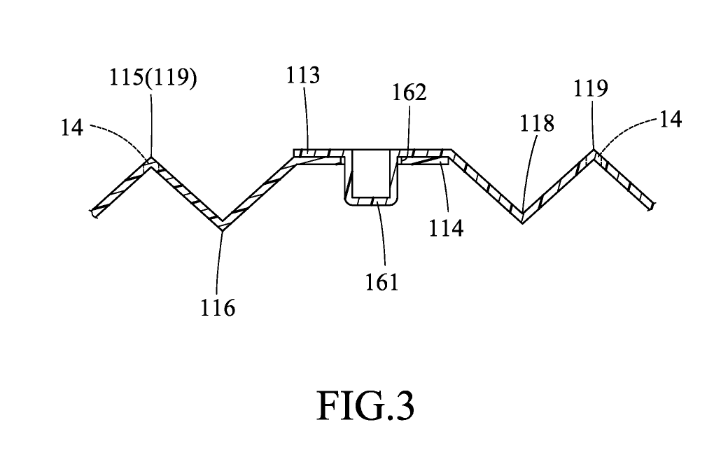

Referring back to FIG. 3, each of the plate members 11 has a pleated configuration to form the guiding grooves 118 and the ridge portions 119. Each of the guiding grooves 118 has a V-shaped cross section, and each of the ridge portions 119 has an inverted V-shaped cross section. In addition, each of the ridge portions 119 is formed with a plurality of vent holes 14, each of which extends from the top surface 115 to the bottom surface 116.

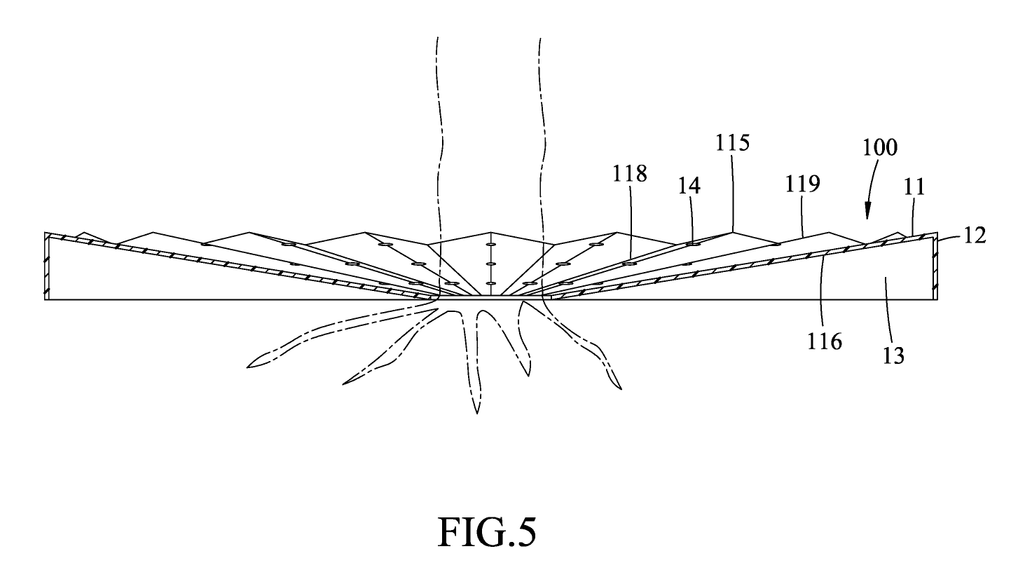

The planting dish 100 may be used to grow a plant in a ground area. The plant is first placed in the ground area before the planting dish 100 is put around the plant. Referring back to FIG.1, before the plate members 11 are assembled around the plant (see FIG. 5), the first securing member 161 and the second securing member 162 of one of the plate members 11 are oriented to be respectively aligned with the second securing member 162 and the first securing member 161 of the other one of the plate members 11. Likewise, the first and second side portion 113, 114 of one of the plate members 11 are arranged to respectively face the second and first side portion 114, 113 of the other one of the plate members 11. In addition, the plate members 11 are spaced apart from each other so that they are open to allow the plant to access to the central hole 110 of the dish body 10.

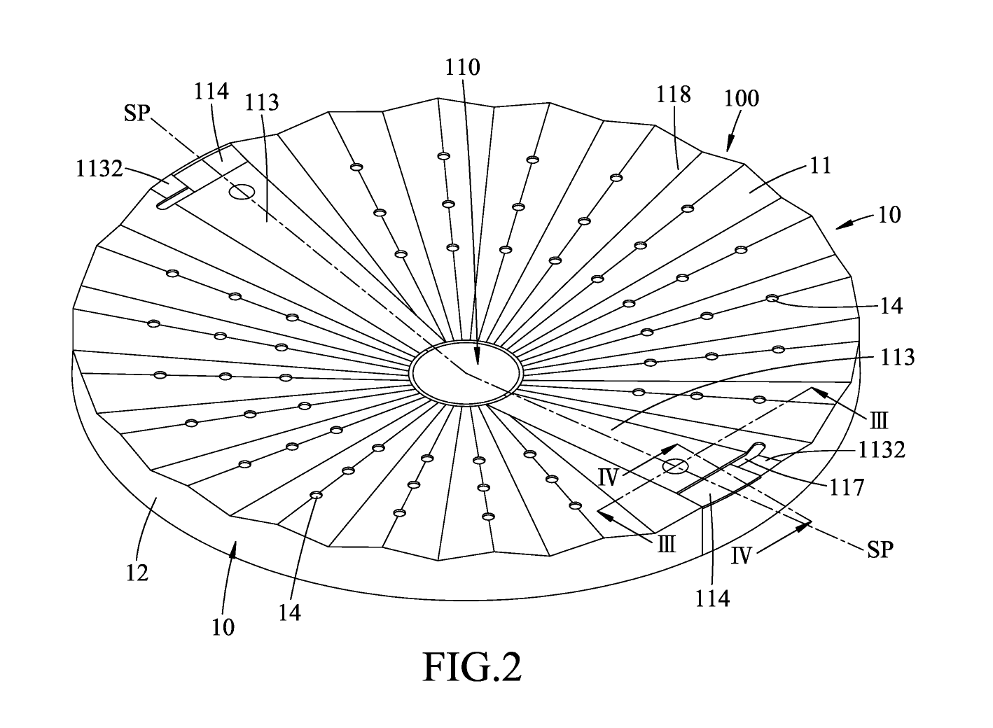

After the plant is placed in the central hole 110, the plate members 11 are assembled together. Referring to FIGS. 2 to 5, to assemble the plate members 11, the first securing member 161 on each of the plate members 11 is engaged with the second securing member 162 on the other one of the plate members 11, and the second side portion 114 of each of the plate members is engagedly inserted into the slit 117 of the first side portion 113 of the other one of the plate members 11 so that the plate members 11 are kept in a closed position. As shown in FIG. 5, the dish body 100 covers at least a region of the ground area immediately above the root of the plant.

As best shown in FIG. 3, the first securing member (protrusion) 161 is inserted into the respective second securing member (through hole) 162.

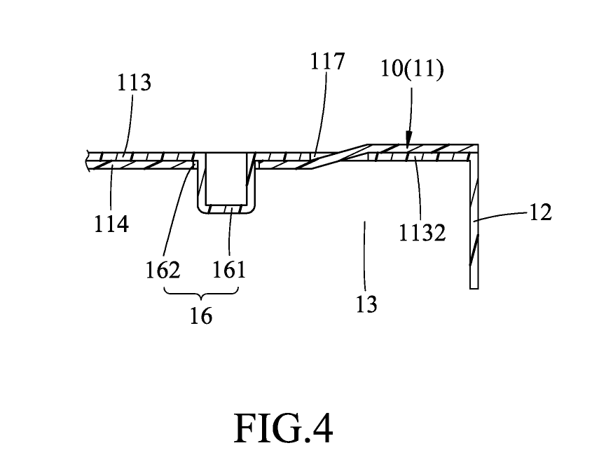

Referring back to FIGS. 1 and 4, when the second side portion 114 of each plate member 11 is engagedly inserted into the slit 117 of the other plate member 11, the second side portion 114 extends over the top surface 115 of the flap section 1132 of the first side portion 113 (best shown in FIG. 4) and under the bottom surface 116 in the remaining part of the first side portion 113.

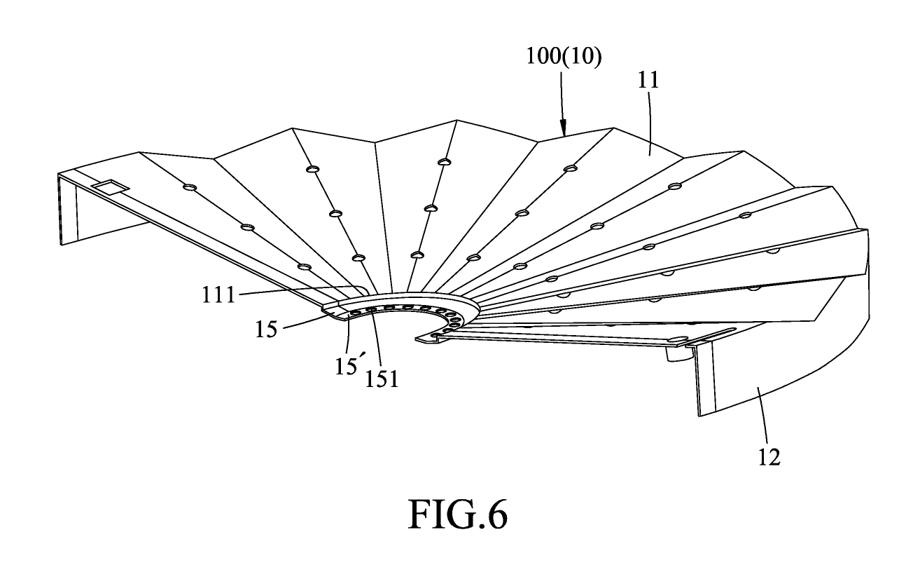

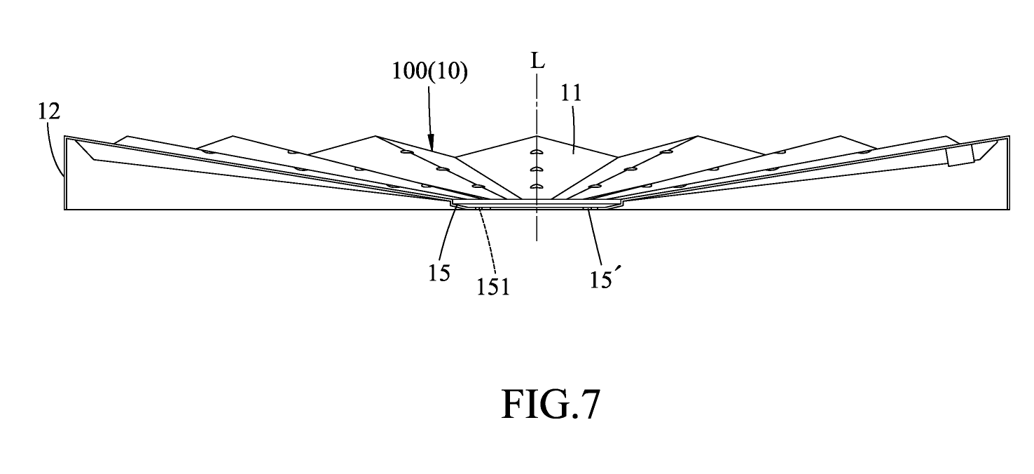

Referring to FIGS. 6 and 7, a second embodiment of the planting dish 100 of the disclosure is similar to that of the first embodiment. However, each of the plate members 11 further has two auxiliary plates 15, 15′ that are removably connected to the inner edge 111 and that surrounds the central hole 110. The auxiliary plates 15, 15′ are disposed between the inner edge 111 and the central hole 110, such that water may be guided closer to efficiently water the root of the growing plant. During the growth of the plant, the auxiliary plates 15, 15′ may be removed sequentially when stem of the plant becomes thicker. In this embodiment, the two auxiliary plates 15, 15′ are disposed one around the other, and the auxiliary plate 15′ proximate to the central hole is formed with a plurality of perforations 151 for ventilation.

It should be noted that, while the dish body 10 of planting dish 100 has two plate members 11 in the first embodiment, the number of plate members 11 is not restricted to two. It is possible to have three or more plate members 11. In the first embodiment, the dish body 10 forms two openable splits (SP) between the two plate members 11 and on two opposite sides of the central hole 110 so that the dish body 10 can be opened along the two splits (SP) to allow access of the plant to the central hole 110.

According to another embodiment, the dish body may also have a single-piece plate member. The single-piece plate member may include a central hole, an annular inner edge surrounding and adjoining the central hole, an annular outer edge surrounding the annular inner edge, a top conical surface that is defined between the annular inner and outer edges and that slopes downward from the annular outer edge to the annular inner edge, and a single split that extends from the central hole to the annular outer edge to intersect the annular inner and outer edges and that is openable to allow access from the annular outer edge to the central hole. The single-piece plate member may further has first and second side portions on two opposite sides of the single split, and first and second securing members respectively disposed on the first and second side portions. The plant may be placed in the central hole when the single one split is opened. After the plant is placed in the central hole, the split may be closed.

In summary, the planting dish of this disclosure is structurally simple and easy to use. Weed would be prevented from growing thereabove when the dish body 10 of the planting dish 100 covers at least a region of the ground area directly above the root of the plant. In addition, the V-shaped configuration of the guiding grooves 118 is helpful for guiding water toward the root of the plant, given that the guiding grooves 118 are slopingly indented toward the central hole. Although the vent holes 14 may leak water, the vent holes are placed on the ridge portions 119 to minimize the amount of water passing therethrough, while maintaining air circulation around the root of the plant. Lastly, the planting dish 100 is made of light and portable plastic material convenient for assembly and disassembly, which is especially useful when the planting dish 100 has to be temporarily removed for applying fertilizers to the plant, and the space 13 of the dish body 10 ensures that the fertilizers are less likely to be washed away by rainwater.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A planting dish for growing a plant in a ground area, comprising:
a dish body, and a fastening unit;
said dish body being made from an impervious material and configured to surround the plant and to cover a region of the ground area immediately above a root of the plant, said dish body including a central hole for the plant to pass therethrough and at least two plate members which are arranged in an annular array around said central hole;
each of said plate members including an inner edge that surrounds and adjoins said central hole, an outer edge that surrounds said inner edge, a first side portion that is connected between said inner edge and said outer edge, a second side portion that is connected between said inner edge and said outer edge and that is angularly spaced apart from said first side portion, and a top surface defined by said inner and outer edges and said first and second side portions;
said top surfaces of said plate members cooperatively forming a conical top surface that slope downward from said outer edges to said inner edges of said plate members;
said first side portion of each of said plate members and said second side portion of the other one of said plate members being juxtaposed with each other and being movable away from each other to allow access of the plant to said central hole;
said fastening unit including a first securing member formed on said first side portion of each of said plate members, and a second securing member formed on said second side portion of each of said plate members; and
said first securing member on each of said plate members being releaseably engageable with said second securing member on the other one of said plate members.

2. The planting dish as claimed in claim 1, wherein each of said plate members has a bottom surface opposite to said top surface, said first securing member being formed as a protrusion protruding downward from said bottom surface, said second securing member being formed as a through hole extending through said top surface and said bottom surface for engagement of said protrusion.

3. The planting dish as claimed in claim 2, wherein each of said plate members is further formed with a slit that extends through said top and bottom surfaces in said first side portion and that intersects a terminating edge of said first side portion connected between said inner and outer edges, said second side portion of each of said plate members being engagedly inserted into said slit of said first side portion of the other one of said plate members.

4. The planting dish as claimed in claim 2, wherein each of said plate members further includes a peripheral wall that peripherally and downwardly projects from said outer edge, said peripheral walls and said bottom surfaces of said plate members cooperatively defining a space that opens downward.

5. The planting dish as claimed in claim 1, wherein each of said plate members is further formed with a plurality of guiding grooves that are slopingly indented from said top surface between said first and second side portions and that radially extend from said inner edge to said outer edge.

6. The planting dish as claimed in claim 5, wherein each of said plate members is further formed with a plurality of ridge portions that protrude from said top surface and that alternate with said guiding grooves, each of said ridge portions being formed with a plurality of vent holes, each of which extends from said top surface to said bottom surface.

7. The planting dish as claimed in claim 6, wherein each of said plate members has a pleated configuration to form said guiding grooves and ridge portions.

8. The planting dish as claimed in claim 6, wherein each of said guiding grooves of said plate members has a V-shaped cross section, each of said ridge portions having an inverted V-shaped cross section.

9. The planting dish as claimed in claim 1, wherein each of said plate members further has at least one auxiliary plate that is removably connected to said inner edge and that surrounds the central hole, said at least one auxiliary plate being disposed between said inner edge and said central hole.

10. The planting dish as claimed in claim 9, wherein said at least one auxiliary plate includes two auxiliary plates that are disposed one around the other, at least one of said auxiliary plates being formed with a plurality of perforations.

11. A planting method comprising:
providing a planting dish that is made from a water-impervious material and that includes a dish body, said dish body having a central hole, an annular inner edge surrounding and adjoining the central hole, an annular outer edge surrounding the annular inner edge, a top conical surface that is defined between the annular inner and outer edges and that slopes downward from the annular outer edge to the annular inner edge, and at least one split that extends from the central hole to the annular outer edge to intersect the annular inner and outer edges and that is openable to allow access from the annular outer edge to the central hole;
planting a plant into a ground area; and
placing the planting dish around the plant such that the plant extends through the central hole and the dish body covers at least a region of the ground area immediately above the root of the plant, wherein the plant is placed in the central hole when the at least one split is opened, and after the plant is placed in the central hole, the at least one split is closed.

12. The planting method of claim 11, wherein the planting dish further has a fastening unit to keep the at least one split in a closed position.
